(19) United States
(12) Patent Application Publication
(10) Pub. No.: US 2004/0247763 A1
(43) Pub. Date: Dec. 9, 2004

(54) Method for preparing a fully cooked, oven roasted shelf stable meat product

(76) Inventor: James Daniel Shull, Coquille, OR (US)

Correspondence Address: James Daniel Shull, 2100 Shelley Road, Coquille, OR, 97423, US

(21) Appl. No.: 10/456,918

(22) Filed: Jun. 9, 2003

(51) Int. Cl. A23C 3/00

(52) U.S. Cl. 426/523

(57) ABSTRACT

A method for preparing a fully cooked or oven roasted shelf stable meat product comprising of the steps of first mixing a selected group of ingredients which may include flavorings, colors, preservatives, sweeteners, salt, cures, fillers, bulking agents, edible acids, antimicrobials, antioxidants, concentrated proteins, emulsifiers, fats and oils, and others into a brine solution; injecting the ingredients and/or tumbling the ingredients with the selected meat product to create a homogeneous mixture; fully cooking or oven roasting the blended meat product to meet USDA regulations; chilling the cooked product; forming, cutting, shaping, and styling the product; and packaging the product; and pasteurizing the finished product.

### CROSS REFERENCE TO RELATED APPLICATIONS

U.S. Patent Documents

| | | |
|---|---|---|
| 4248902 | Feb., 1981 | Eapen, et al. |
| 4356203 | Oct., 1982 | Ueno, et al. |
| 4358468 | Nov., 1982 | Dolman, et al. |
| 4455928 | Jun., 1984 | Townsend |
| 4463027 | Jul., 1984 | Chandler, et al. |
| 4463028 | Jul., 1984 | Chandler, et al. |
| 4798729 | Jan., 1989 | Anders, et al. |
| 4886673 | Dec., 1989 | Hamnes |
| 4888191 | Dec., 1989 | Anders, et al. |
| 5300312 | Apr., 1994 | Lusts, et al. |
| 5945152 | Aug. 1999 | Purser |
| 6165528 | Dec., 2000 | Tanaka, et al. |
| 6509050 | Jan., 2003 | Henson, et al. |

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### BACKGROUND OF THE INVENTION

This invention relates to a method for processing meat products and other ingredients to produce a fully cooked or oven roasted shelf stable meat product. Further, this invention relates to a method comprising a series of mixing, injecting and/or tumbling, cooking or roasting, chilling, packaging, and pasteurization resulting in a fully cooked or oven roasted meat product that has a taste and texture similar to that of freshly cooked or roasted meat. Said product will remain free from pathogen-causing levels of bacteria and can be stored for an extended period of time without refrigeration due to antimicrobial properties of the ingredients used.

Approximately two-thirds of the world population does not have access to refrigeration for storing food products that would be lost due to spoilage without refrigeration. As a result, this group of the world population does not have access to consuming meat products that require refrigeration. All meat products contain meat proteins that are a source of good nutrition in the human diet. Meat and meat products have historically been an important part of the diet in parts of the world where refrigeration is common. The method and product described herein provides a source of meat protein that has an extended shelf life without refrigeration and also a texture and flavor similar to that of a freshly cooked or roasted meat product. Other flavoring ingredients can be added to provide products for acceptance within a particular culture.

USDA has certain government regulations that must be met for a product to be classified as shelf stable. Good Manufacturing Practices that will provide for a shelf stable product must be met in other areas of the world where USDA does not have jurisdiction. Shelf stable meat products must be able to be stored for extended periods of time without refrigeration without compromising product quality and flavor due to microbial deterioration or oxidative reduction. For a shelf stable meat product to be safe for consumption, the product should be able to inhibit mold and yeast growth, reduce the growth rates of microorganisms present, and inhibit the growth of new bacteria. The shelf stable meat product must maintain a favorable taste.

The term “shelf stable product” refers to a product that is preferred to have a mouth feel and texture that is similar in mouth feel and texture to freshly cooked product. The product must exhibit properties that enable the product to resist significant levels of microbial growth when stored without refrigeration for an extended period of time. The shelf stable product depends on the amount of moisture available for microorganism growth and nutritive support, on the pH of the product, on the oxygen availability, and on the proper initial cooking conditions among other elements. The proper selection of ingredients used to manufacture the product is also important.

U.S. Pat. No. 4,358,468 issued to Dolan, et al. discloses a method of cooking vegetable proteins to produce a pet food that resembles lean meat marbled with fat. Shelf stability of this product is achieved by using unspecified amounts of aqueous solutes. This technology does not, however, utilize meat as the predominant ingredient.

U.S. Pat. No. 4,798,729 issued to Anders, et al. describes a method for delaying Clostridium botulinum growth in a foodstuff selected from the group consisting of fish and poultry by adding a lactate salt to the fresh foodstuff in an amount of 1% to 7% by cooking the foodstuff at high humidity to a temperature sufficient to cook the foodstuff, but not sufficient to sterilize the foodstuff, by cooling the cooked foodstuff, and by packaging the foodstuff in a plastic barrier package.

U.S. Pat. No. 4,888,191 issued to Anders, et al. describes a method for delaying Clostridium botulinum growth in a foodstuff selected from the group consisting of fish and poultry by adding a lactate salt to the fresh foodstuff in an amount of 1% to 7% by packaging the foodstuff in a plastic barrier package, by cooking the foodstuff at high humidity to a temperature sufficient to cook the foodstuff, but not sufficient to sterilize the foodstuff, and by cooling the cooked foodstuff.

U.S. Pat. No. 5,300,312 issued to Lusas, et al. describes a method of processing vegetable protein with other ingredients by extrusion cooking, after which meat products are added to produce an intermediate moisture vegetable food product resembling meat. This method requires mechanical drying and re-extrusion to produce the final product. This two-step extruded product utilizes a process and ingredients approved by the FDA, rather than the USDA.

U.S. Pat. No. 5,945,152 issued to Purser discloses a method mixing ingredients that act as antimicrobials and other ingredients used for controlling end product water activity and cooking the mixture resulting in pasteurization using a scraped surface heat exchanger for pasteurization. The product is then cooled to ambient temperature and packaged under anaerobic vacuum using a moisture/microbe impermeable barrier.

### BRIEF SUMMARY OF THE INVENTION

This invention relates to a method of preparing a fully cooked or oven roasted shelf stable meat product comprising of first mixing a selected group of ingredients into a brine solution; injecting the brine solution and/or tumbling the brine solution with the selected meat product to create a homogeneous mixture; fully cooking or oven roasting the blended meat product to meet USDA regulations; chilling the cooked product; forming, cutting, shaping, or styling the product; packaging the product; and pasteurizing the finished product.

The invention also relates to a food product prepared by the method described above.

### BRIEF DESCRIPTION OF THE SEVERAL VIEWS OF THE DRAWING

Not Applicable

### DETAILED DESCRIPTION OF THE INVENTION

The foodstuffs included in this invention can include red meat such as beef, pork, and lamb and non-red meat foodstuff such as chicken, turkey, fish, goose, or duckling. This invention is particularly useful to provide protein containing food products to areas of the world where refrigeration is nonexistent.

A number of other ingredients including flavorings, colors, preservatives, sweeteners, salts, cures, fillers, bulking agents, edible acids, antimicrobials, antioxidants, concentrated proteins, emulsifiers, fats and oils, and other ingredients well known in the art are also used in the invention. All added ingredients must be edible and approved by either the USDA or FDA.

The effects of acids on inhibiting microbial growth are well known in the food industry. Food grade edible acids such as acetic (vinegar), citric, lactic, fumaric, and ascorbic can all be used.

An ingredient used in this invention includes salt, a common food preservative. Another ingredient used is lactate salt such as sodium lactate, calcium lactate, and potassium lactate, another food preservative or flavor. Other ingredients used to increase shelf life may include but may not be limited to sodium diacetate, citric acid, Protecta Super, and lactic acid. Curing ingredients used may include sodium nitrite, potassium nitrite, sodium erythorbate, and ascorbic acid. Flavoring ingredients are unlimited to achieve any particular desired flavor. Sodium phosphates or potassium phosphates may be used to enhance the textural qualities of the finished product.

The ingredients used as preservatives will be used in an amount from 0.10% to 6.00%. The different amounts of preservative type ingredients used vary from ingredient to ingredient. The amount of salt used is self limiting. The amounts of curing ingredients used are controlled by USDA or by the agricultural department of other countries as specified. The amount of each flavoring ingredient used will vary depending on the flavor profile desired.

### EXAMPLE I

A brine solution is made using the following ingredients. Water is used at 42.5%. Salt is used at 17.4%. Sodium nitrite is used at 0.1%. Sodium erythorbate is used at 0.5%. Protecta Super is used at 2%. Sodium phosphates are used at 4.2%. Sodium lactate is used at 33.3%.

This brine solution is injected into chicken drumsticks at a level not to exceed ten percent of the weight of the uninjected chicken drumsticks. The injected chicken drumsticks are cooked to a minimum of 155 degrees F., as required by USDA. The cooked chicken drumsticks are chilled, may be cut or portioned, packaged as described above, and pasteurized.

### EXAMPLE II

A brine solution is made using the following ingredients. Water is used at 66.9%. Salt is used at 9.2%. Sodium nitrite is used at 0.05%. Sodium erythorbate is used at 0.25%. Protecta Super is used at 1%. Sodium phosphates are used at 2.0%. Sodium lactate is used at 8.2%. Sodium diacetate is used at 0.6%. Lactic acid is used at 8.8%. Turkey flavor is used at 3.0%.

This brine solution is tumbled into turkey dark meat at a level not to exceed twenty percent of the weight of the unmarinated turkey dark meat. The marinated turkey dark meat is cooked to a minimum of 155 degrees F., as required by USDA. The cooked turkey dark meat is chilled, may be cut or portioned, packaged as described above, and pasteurized.

I claim:

1. A method for preparing a fully cooked or oven roasted shelf stable meat product comprising of the steps of first mixing a selected group of ingredients into a brine solution; injecting the brine solution and/or tumbling the ingredients with the selected meat product to create a homogeneous mixture; fully cooking or oven roasting the blended meat product to meet USDA regulations; chilling the cooked product; forming, cutting, shaping, and styling the product; and packaging the product; and pasteurizing the finished product.

2. The method of claim 1 wherein the selection of ingredients from the group consisting of salts, cures, flavorings, concentrated proteins, fillers, bulking agents, antioxidants, preservatives, and antimicrobials are a primary agent for the amount of available water in said first homogeneous mixture.

3. The method of claim 1 wherein a selected ingredient included is a food grade, edible acid that when added to the homogeneous mixture produces a said end product having a pH of less than about 6.0.

4. The method of claim 1 wherein the brine mixture is added to the selected meat product by tumbling under vacuum.

5. The method of claim 1 wherein the brine mixture is added to the selected meat product by injecting.

6. The method of claim 1 wherein the said cooking step is conducted at a pressure of less than 25 pounds per square inch.

7. The method of claim 1 wherein the product is chilled to a temperature required by the packaging method.

8. The method of claim 1 wherein the product may be reduced in size by forming or cutting.

9. The method of claim 1 wherein the product may be altered in appearance by shaping or styling.

10. The method of claim 1 wherein the packaging step comprises the use of an oxygen and moisture impermeable barrier film to isolate the end product from the ambient atmosphere.

11. The method of claim 1 wherein the packaged product is subjected to pasteurization.

12. The method of claim 1 wherein the source of meat protein is from a group consisting of chicken, turkey, beef, pork, lamb, fish, goose, or duckling.
